(19) United States
(12) Patent Application Publication
(10) Pub. No.: US 2002/0112148 A1
(43) Pub. Date: Aug. 15, 2002

(54) System and method for executing predicated code out of order

(76) Inventors: Perry Wang, San Jose, CA (US); Hong Wang, Fremont, CA (US); Ralph Kling, Sunnyvale, CA (US); Kalpana Ramakrishnan, Sarataoga, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/737,783

(22) Filed: Dec. 15, 2000

(51) Int. Cl. G06F 9/00

(52) U.S. Cl. 712/226

(57) ABSTRACT

According to one aspect of the present invention, a system including a pipeline microprocessor for out-of-order processing of predicated instructions is disclosed. The microprocessor includes multiple dynamic pipeline stages including at least one predicated instruction wherein the predicated instruction includes at least one guarding predicate. The microprocessor also includes a register renaming unit, a reorder buffer, multiple execution units and multiple reservation stations. The register renaming unit, the reorder buffer, the plurality of execution units and the plurality of reservation stations are coupled to at least one of the dynamic pipeline stages. The microprocessor also includes an augmented register alias table. Also disclosed is a method of operating a microprocessor for out-of-order processing of predicated instructions.

### FIELD OF THE INVENTION

The present invention relates to computer systems and more specifically relates to in-order microprocessors using predicated instructions.

### BACKGROUND OF THE INVENTION

In modern processor designs, one method of increasing performance is executing multiple instructions per clock cycle. The performance of such processors is dependent on the amount of instruction level parallelism (ILP) exposed by the compiler and exploited by the microarchitecture. Therefore cooperation between compiler and micro architecture is increasingly important to achieve higher performance.

One approach to improved cooperation between compiler and micro-architecture is using predicated instructions of a predicated execution model.

A predicated execution model is an architectural model where an instruction is guarded by a Boolean operand whose value determines if the instruction is executed or nullified. To explore ILP, a compiler can take full advantage of the predicated execution model by applying a technique referred to as if-conversion. In short, if-conversion is an optimization that converts control flow dependence into data flow dependence. With if-conversion, the compiler can collapse multiple control flow paths and schedule them based only on data dependencies. Even though a predicated execution model exposes more ILP, such a predicated execution model may not always yield enhanced performance. On the compiler side, the predicated execution model requires a detailed analysis of the dynamic behavior of the code and the dynamic resource availability. Since the effectiveness of predication depends on resource availability, the scalability for and compatibility with future-generation machines are important issues to consider. Given the availability of increasing transistor budgets, increasingly more advanced microarchitecture mechanisms can be incorporated. Furthermore, the legacy base of predicated code should be able to continue to perform well on future processor generations.

One example of an advanced microarchitecture is that of a dynamic, or out-of-order, execution model. An out-of-order, execution model is, in general, more complex than a static execution model. Static execution executes code in the order as scheduled statically by the compiler while out-of order execution permits the processor to dynamically adjust instruction scheduling to the run-time behavior of the program. Because of this ability to adapt to the run-time environment, dynamic execution has been employed in many processor designs. The potential performance gains of an out of order execution model are facilitated by two techniques: Register renaming where registers are renamed to eliminate false dependencies and dynamic scheduling where instructions are reordered to reduce unnecessary stalls in the pipeline.

### BRIEF DESCRIPTION OF THE DRAWINGS

The present invention is illustrated by way of example and not limitation in the figures of the accompanying drawings in which like references indicate similar elements.

FIG. 1 illustrates a block diagram of a baseline performance embodiment of one embodiment.

FIG. 1A shows an instruction pipeline of one embodiment.

FIG. 1B illustrates a computer system of one embodiment.

FIG. 1C shows if-conversion process of one embodiment.

FIG. 2 illustrates an instruction pipeline of one embodiment.

FIG. 2A shows a predicate status testing flowchart of one embodiment.

FIG. 3 shows one embodiment of subscripting and inserting a φ node.

FIG. 4 illustrates an instruction renaming process flow of one embodiment.

FIG. 5 illustrates an instruction renaming process flow of one embodiment.

FIG. 6 illustrates an instruction pipeline of one embodiment.

FIG. 7 shows one embodiment of a format of a select-μop.

FIG. 7A shows a flowchart of one embodiment of a method of processing a predicated instruction.

FIG. 8 illustrates one embodiment of an augmented register alias table (RAT) with predicates.

FIG. 9 shows one embodiment of a logic that realizes the dispatching condition.

FIG. 10 illustrates one embodiment of a logic that executes the select-μop with source fan-in.

FIG. 11 shows a dependence graph of one embodiment.

FIGS. 12A-12G illustrate a clock sequence instruction pipeline of one embodiment.

### DETAILED DESCRIPTION

As will be described in more detail below, one embodiment includes a system including a pipeline microprocessor for out-of-order processing of predicated instructions is disclosed. The microprocessor includes multiple dynamic pipeline stages including at least one predicated instruction wherein the predicated instruction includes at least one guarding predicate. The microprocessor also includes a register renaming unit, a reorder buffer, multiple execution units and multiple reservation stations. The register renaming unit, the reorder buffer, the plurality of execution units and the plurality of reservation stations are coupled to at least one of the dynamic pipeline stages. The microprocessor also includes an augmented register alias table. Also disclosed is a method of operating a microprocessor for out-of-order processing of predicated instructions.

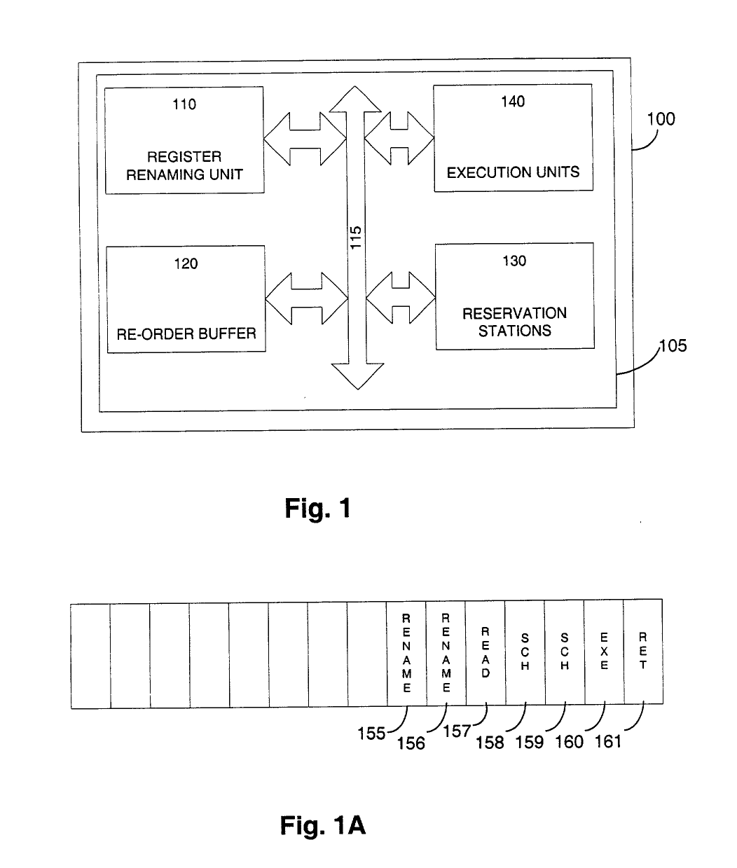

There are several types and variations of an out of order or dynamic execution processors. A dynamic microarchitecture as a baseline performance embodiment is shown in FIG. 1. The baseline performance embodiment includes a dynamic portion 105 of the processor 100 including a register renaming unit 110, which maps between temporary and architectural files, a reorder buffer 120, a plurality of reservation stations 130, and a plurality of execution units 140. A bus 115 couples the register renaming unit 110, the reorder buffer 120, the plurality of reservation stations 130 and the plurality of execution units 140 together and to the remaining portions of the microprocessor which are not shown. The pipeline shown in FIG. 1A has 15 stages, with 7 stages 155-161 devoted to the dynamic portion 105 of the processor 100. The dynamic pipeline 155-161 begins with a 2-stage rename 155-156, followed by a register read stage 157, a 2-stage schedule 158-159, an execute stage 150, and finally a retire stage 161. In the schedule stage 158-159, the instructions wait in the reservation stations 130 until the data of the source operands become available. After the data from the source operands are loaded into the register, the instruction enters the execute stage 150. In the final retire stage 161, the instructions are retired in order from the reorder buffer.

FIG. 1B illustrates another embodiment which includes a computer system 170 having the processor 100 described above. The computer system 170 includes the processor 100, a input/output device 171, a computer memory system 172, and a system bus 175 which couples the computer system components together.

Conventional dynamic execution microarchitectures use reservation stations 130, to remove issue blockages due to pending data dependencies in predicate-free code. To similarly execute predicated code without introducing any additional or special hardware, the baseline performance embodiment treats the guarding predicate of an instruction as one of the source operands.

The baseline performance embodiment poses two performance limitations due to a substantial penalty from stalling the pipeline. Both issues arise because some guarding predicates may not be available when the instructions are ready to advance down the pipeline. One possible cause for the unresolved predicate is that, due to dynamic scheduling, a predicate-defining instruction may not have been executed yet. Another cause could be due to a potential long latency of the predicate-defining instructions. Most predicates are produced by compare instructions. Under normal implementation, compare instructions require a serialized propagation of bit-wise operations. Thus, as the clock frequency and the operand size increase, compare instructions could require multiple cycles to execute.

A first problem occurs during scheduling steps 158, 159 when a predicated instruction continuously waits in the reservation stations 130 for the predicate-defining instruction to finish. A second problem arises at the rename stage 155, 156 before the instructions enter the dynamic portion of the processor. With multiple definitions assigned to a common register, which is guarded by different predicates, the renaming mechanism may need to stall when the predicates are not resolved. As a result, “bubbles” or stalls can be introduced in the pipeline.

For the baseline performance embodiment described above, when a predicate has not yet been produced, all instructions that depend on this predicate must wait in the reservation stations 130. Even if all the other source operands are available, the instruction cannot be executed until the predicate is ready. In situations where some predicates have not been resolved, the reservation stations 130 will start to pile up with those instructions having unresolved guarding predicates. As a result, the reservation stations 130 can become saturated quickly and induce backpressure on the pipeline. In other words, because of the unresolved predicates, the pipeline may stall due to the saturation of reservation station 130 entries, thereby causing performance losses.

On the compiler side, through compiler analysis, a variable is deemed live at a point of the control flow graph if the variable's value at that point can reach a subsequent use. The same variable can be defined elsewhere along another control flow path. These paths of multiple variable definitions can meet, resulting in overlapping variable lifetimes. When the compiler picks these paths for an if-converted region, the variable definitions are assigned to a common register, with the corresponding overlapping lifetimes guarded by different predicates. As this straight-line if-converted region is executed, the processor encounters several instructions which, guarded by different predicate registers, write to the same register. The left side 180 of FIG. 1C shows a variable with overlapping lifetimes in two definition paths 182,183. The variable is assigned to register r40, and after if-conversion 188, the variable is guarded by two different predicates p9, p3.

The performance of a dynamic execution processor can degrade with the above described predicated code sequence. When a consumer instruction reaches the rename stage 155, 156, the renaming of the common register becomes ambiguous if the guarding predicates of the defining instructions are not resolved. In the middle 190 of FIG. 1C, two add instructions, guarded by p9 and p3, assign their respective results to the same architectural register r40. After renaming 194, the result register is renamed to rB and rC, respectively. A mov instruction that uses or consumes the result register follows immediately in the pipeline. If the mov instruction enters the rename stage before predicates p9 and p3 are evaluated, then the processor cannot correctly determine whether to rename r40 to physical registers rB or rC. Therefore, the processor stalls the consumer instruction, the mov instruction before entering the mov instruction into the rename stage.

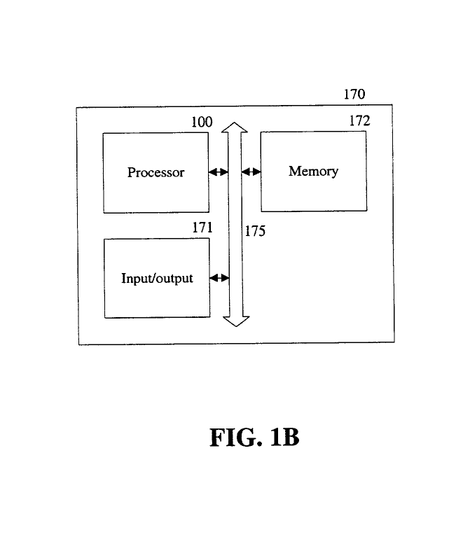

FIG. 2 illustrates where the instructions may have traveled in the pipeline 200. In FIG. 2, the add instructions have already advanced down the pipeline. As mentioned before, if predicates p9 and p3 have not yet been resolved, the mov instruction must wait indefinitely before the entering rename stage 210. After the predicates p9 and p3 become resolved, the mov instruction can then advance down the pipeline 200 into the rename stage 210 to rename the mov instruction source operand to rB or rC.

A consumer instruction is not required to wait for the resolution of all guarding predicates of the defining instructions as shown in FIG. 2A. The consumer instruction must only wait for the latest defining instruction that is guarded true. Therefore, the consumer instruction first waits for the predicate of the last of the defining instructions to become available 256. If the predicate of the last of the defining instructions turns out true 258, the consumer instruction can immediately advance in the pipeline 200 and, in this example, use the physical register of the last defining instruction, despite the outcome of other defining instructions. If the last defining instruction is not true i.e. nullified, then the consumer instruction must wait for the predicate of the second-to-last defining instruction 260. The process repeats until a latest defining instruction is guarded true. This prioritized checking scheme for the predicate values affects performance depending on the order those values become available. It will be further appreciated that the instructions represented by the blocks in FIG. 2A is not required to be performed in the order illustrated, and that all the processing represented by the blocks may not be necessary to practice the invention.

According to baseline performance embodiment described above, the simple dynamic processor that runs predicated code could suffer from excessive pipeline stalls due to scheduling and renaming issues as described above. One alternative embodiment postpones the predicated instructions down the pipeline and resolves the predicated instructions without significant change to the existing dynamic execution microarchitecture.

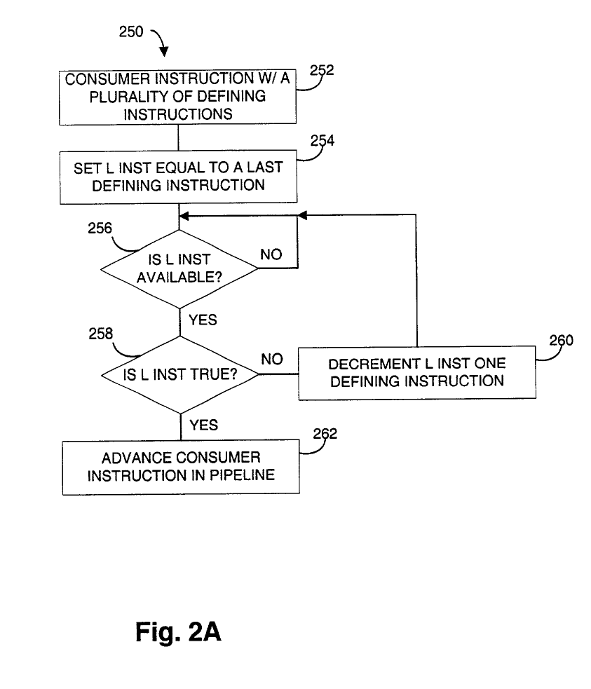

For one embodiment, a select-μop addresses the issue of overlapping variable lifetimes. A select-μop eliminates the ambiguity of renaming by effectively postponing the renaming task. Using the select-μop reduces the stall cycles while enable renaming of registers without stalling the pipeline for disambiguating renaming. A select-μop is a single-assignment form that guarantees that every target operand is uniquely defined by only one instruction. Thus, when a variable is defined in several basic blocks throughout a control flow graph, each definition instance of the variable is subscripted to be uniquely differentiated from other definition instances of the variable. If multiple definition instances of the variable reach a common use of the variable, then a consumer instruction cannot determine which of the subscripted variables to use. For one embodiment, the compiler inserts a φ-node as a special placeholder at where two definition instances merge. The two subscripted definition variables are used as the source operands of the new φ-node, and a new subscripted variable is created as the new destination operand. From that point on, all subsequent uses of the variable are replaced with the new subscripted variable defined by the φ-node. One embodiment of subscripting and inserting a φ node is illustrated in FIG. 3.

One embodiment of the select-μop mechanism includes register renaming in a processor model similar to subscripting a variable in a compiler. As described above, when a common defined register guarded by different predicates is renamed to different physical registers, a consumer instruction cannot rename the corresponding source register correctly until the predicates are resolved. The processor then dynamically introduces special operators named select-μops to defer the exact renaming resolution of physical registers. By injecting a select-μop into the instruction stream, the select-μop indicates that multiple renamed registers defined under different predicates may have reached a common use. The multiple renamed registers and the corresponding guarding predicates are assigned to the source operands of the select-μop. A new renamed register allocated for the result of select-μop can then be referenced by all subsequent consumer instructions. Upon execution of the select-μop, the data from one of the renamed registers is assigned to the result accordingly.

With the select-μop mechanism, the consumer instructions do not need to stall for the resolution of the guarding predicates of the defining instructions. At the rename stage, the consumer instructions can safely reference to the destination of the select-μop, knowing that the select-μop will, upon execution, choose the correct value among all the renamed registers. Thus, the renaming ambiguity is delayed and later gracefully deciphered via the execution the select-μops. In essence, using select-μop postpones the resolution of the renaming ambiguity to the latter stages of the pipeline, hence allowing the renaming activity in the early stages to continue.

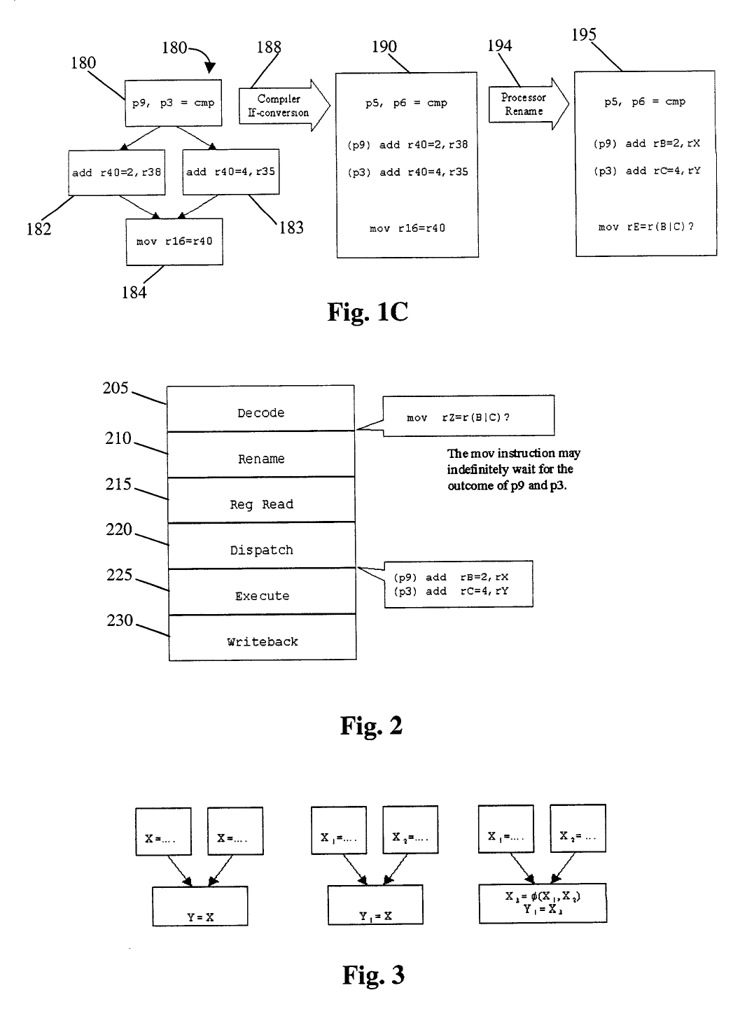

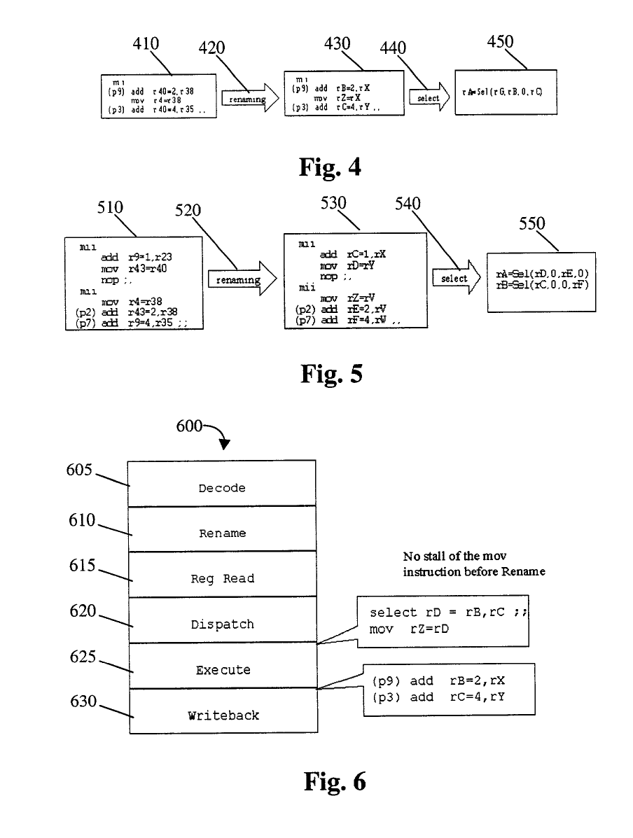

Two embodiments are shown in FIG. 4 and FIG. 5. The first embodiment, FIG. 4, has two predicated instructions assigned to r40 410 which are renamed to rB rC as the source operands 450. The exact syntax of the select-μop is explained in more detail below. The second embodiment shown in FIG. 5 also has two predicated instructions 510, but the predicated instructions assign the result to two different registers r43 and r9. Both registers r43 and r9 have been assigned in a preceding cycle. Thus, two distinct select-μops are produced 550.

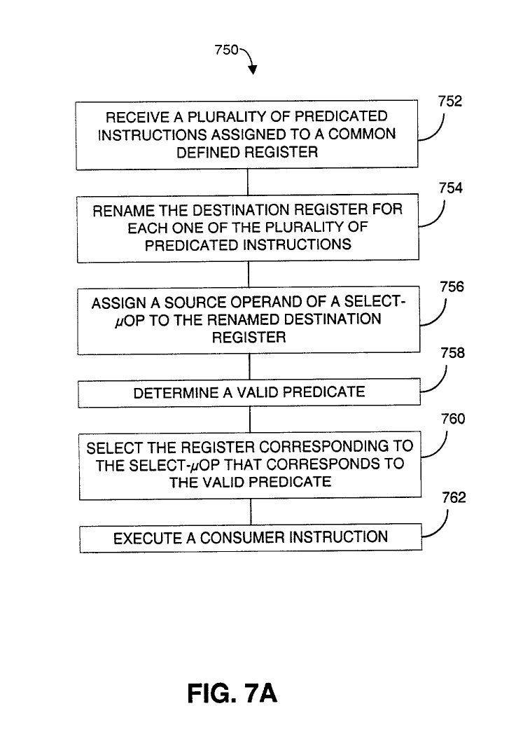

FIG. 6 illustrates placing the code from the first embodiment of FIG. 4, in the pipeline 600 diagram, with the mov instruction that uses r40 immediately following the definitions; the pipeline does not need to stall. In contrast, the pipeline would stall without the select-μops.

For one embodiment, the select-μop has only one destination operand, and therefore the select-μop in theory can have numerous source operands as long as the large fan-ins of the source can be efficiently implemented. For one embodiment, the select-μop has four source operands, s0, s1, s2, and s3. For alternative embodiments, more or less source operands could also be used. The source operands record physical register identifiers. Except for s0, each one of the source operands s1, s2, and s3 is associated with two status bits, a v-bit and a p-bit. The status bits control the selection of the source operands. The first one of the status bits, the v-bit, specifies whether the register is ready. The second status bit, the v-bit, indicates whether the renamed definition register has been architecturally committed. The operation of the status bits is explained in more detail below.

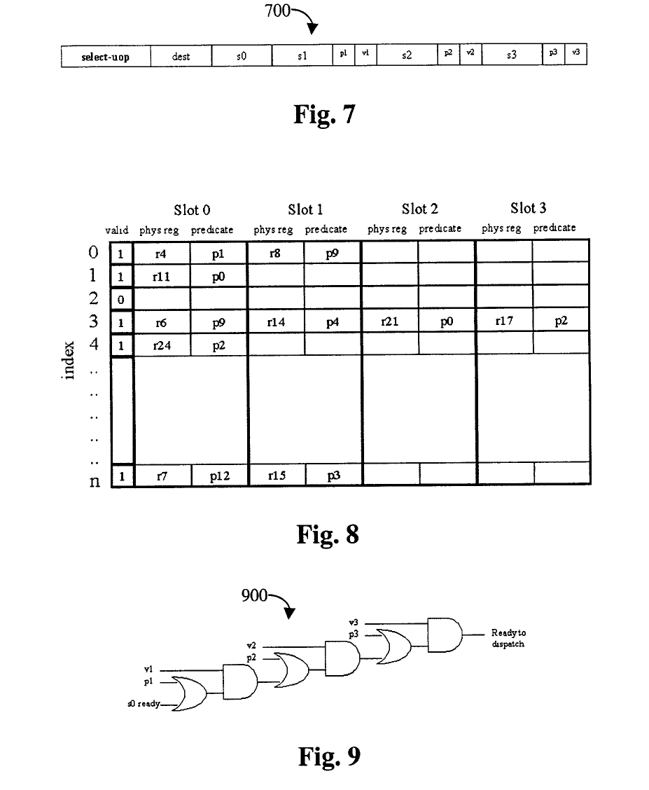

The operand s0 contains a default physical identifier. Upon execution of select-μop, when the other source operands are not selected, the result is assigned with the default identifier s0. Thus, the register indexed by the default identifier must always be valid and available. As a result, s0 is not associated with any status bits. The format of the select-μop is shown in FIG. 7.

For an embodiment having four source operands, the processor can encounter two, three, or four instructions that define register R before generating a select-μop to resolve renaming ambiguity for register R. The generation of select-μop is triggered by two conditions. First, each one of the defining instructions, except the first defining instruction, must be guarded by unresolved predicates. And second, because the first instruction defines the default identifier, the first instruction must be either: An un-predicated instruction, or a predicated instruction whose predicate has been resolved true, or a previously generated select-μop.

Register R is renamed to different physical registers as R's defining instructions enter the rename stage. The physical identifiers are recorded by the renaming mechanism. When the select-μop is to be generated, the recorded identifiers are copied to the source operands of the select-μop. The sO operand is copied with the physical identifier defined by the first instruction. The rest of one, two, or three physical identifiers fill the source operands in the order from s1 to s3. The processor then allocates a new physical register and assigns it to the destination (dest) operand. Thus, this format handles at most three parallel predicated instructions writing to the same register. Therefore, any of the four source operands is a candidate that potentially holds the final value, and the destination operand is where the final value is assigned. Once the select-μop is formed, the processor inserts the select-μop with the in-flight instructions and loads the select-μop into the reservation station. The renaming unit, which does not need to wait for the resolution of the select-μop, can then rename the subsequent uses of register R to the destination register of the select-μop. The priority information of the source operands is inherent in the select-μop, with s3 representing the highest priority. When the status bits of s3 indicate the operand is valid and ready, the select-μop can immediately be executed without waiting on the resolution of the rest of the source operands. For one embodiment, the priority of the source operands is laid out, from left to right, in the program order that the instructions are fetched. Thus, the youngest defining instruction always has the highest priority.

One embodiment is a method 750 of processing predicated instructions as shown in FIG. 7A. First, receiving a plurality of predicated instructions assigned to a common defined register in block 752. At least one of the predicated instructions is out of order in a dynamic pipeline. Next, in block 754, the destination register for each one of the predicated instructions is renamed. Then, the renamed destination register with the predicate register of the predicated instruction is assigned to the source operand of a select-μop, as shown in block 756. Next, a valid predicate is determined in block 758. The register corresponding to the select-μop that corresponds to the valid predicate is selected in block 760. A consumer instruction is executed in block 762 wherein the consumer instruction uses the data from the register corresponding to the valid predicate. It will be further appreciated that the instructions represented by the blocks in FIG. 7A is not required to be performed in the order illustrated, and that all the processing represented by the blocks may not be necessary to practice the invention.

One embodiment of implementing select-μop microarchitecture in the above described baseline performance embodiment is hereafter described. The description of the microarchitecture is separated into two components, one component describing generating the select-ops, and the other component describing executing the select-μops.

For one embodiment, the select-μops include use of a register alias table (RAT) with predicates. There are several approaches to support the generations of select-μops as described above. For one embodiment, the RAT is augmented and used in the rename stage with predicates. The RAT is used by the renaming unit to map from architectural register identifiers to physical register identifiers. When an in-flight instruction enters rename, the RAT looks up the physical identifiers of the source operands as well as assigns the result operand with a new physical identifier.

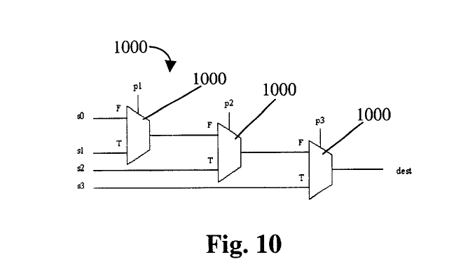

For one embodiment of the augmented RAT, each entry is expanded to have multiple slots, with each slot recording the identifiers of the physical register as well as the guarding predicate of the instruction that defines this physical register. A logic view of the augmented RAT is shown in FIG. 8. Each row (entry) is assigned an architectural register whose identifier is used to index to the entry. Thus the number of architectural registers determines the number of rows in the RAT. For an embodiment of the RAT to support the select-μops with four source operands, each row of this table consists of a valid bit and four slots. Alternative embodiments with more or less source operands can similarly be constructed and used.

In the rename stage, the augmented RAT operates in three steps for the result register of an in-flight instruction. First, index into the RAT with the architectural identifier of the result register. Next, for the located entry, check the predicate of the instruction, i.e.: If the instruction is not predicated, clear the entire entry. If the predicate matches one of the predicates in the slots, clear its associated slot. Then, allocate a new physical register and append to a slot the physical identifier along with the identifier of the guarding predicate. A select-μop is required only when two or more slots are occupied.

For an alternative embodiment, a select-μop is injected only when a select-μop is required so as to avoid injecting excessive select-μops. Injecting a select-μops is demand-driven, that is, when more than one slot is occupied in the entry, plus when either of:

The use of the register is encountered at the rename stage,

Or

All slots in the entry are occupied and a new physical identifier is being allocated,

Or

One of the guarding predicates in the slots is re-defined.

When any one of the above conditions is met, a select-μop is generated. Physical identifiers in all of the occupied slots are copied to the source operands of the select-μop. A new physical register is allocated for the destination operand. Then, the select-μop is treated as an un-predicated instruction. That is, the entire entry in the RAT is cleared and replaced with the new physical register identifier.

For one embodiment, once a select-μop is loaded into the reservation station like any other instruction, the reservation station holds the instructions and receives broadcasted data through the bypass network. When the select-μop's source operands become available, the instruction can be dispatched.

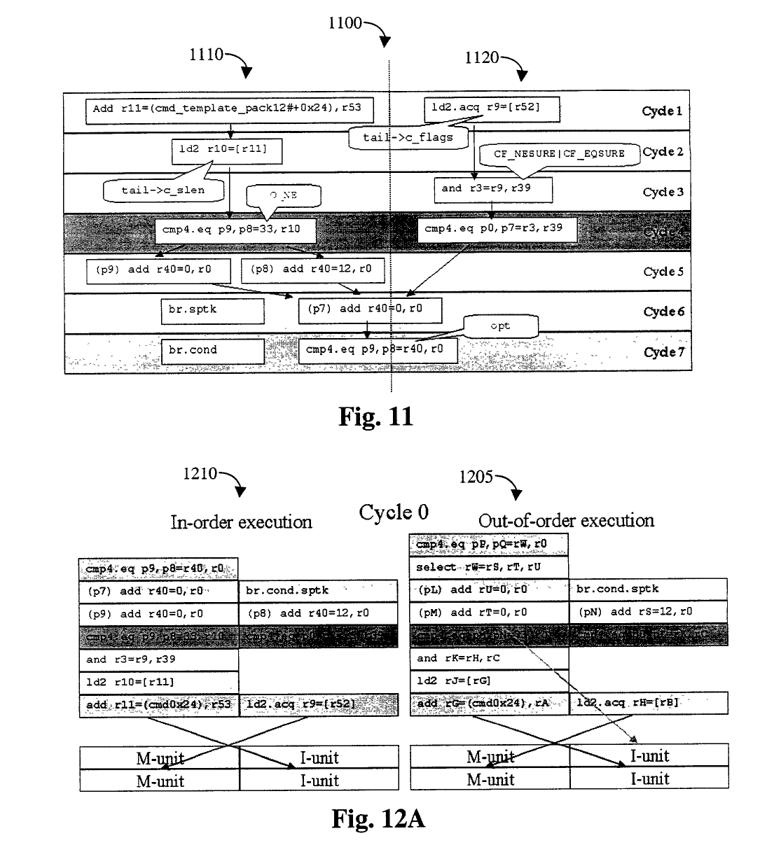

For one embodiment of a dynamic execution model, the reservation station receives two bits of bypassed information for the status bits of the source operands in a select-μop. One bit (bit1) signals that the computation of the operand has completed and the bypassed data is ready. Bit1 corresponds to the v-bit of the source operand. The other bit (bit2) indicates whether the bypassed data is to be committed or discarded, which is equivalent to the predicate of the result-producing instruction. Bit2 corresponds to the p-bit of the source operand. The status bits, v-bit and p-bit, in the select-μop determine the select-μop dispatch policy. One embodiment of the logic 900 that realizes the dispatching condition with the source fan-in of 4 is shown in FIG. 9. When the highest priority operand (s3) is available, v3 becomes 1. Depending on p3, which is the predicate value, the select-μop can be immediately dispatched if p3 is 1. If p3 is 0, the select-μop must wait for the select-μop's lower priority operands to become available.

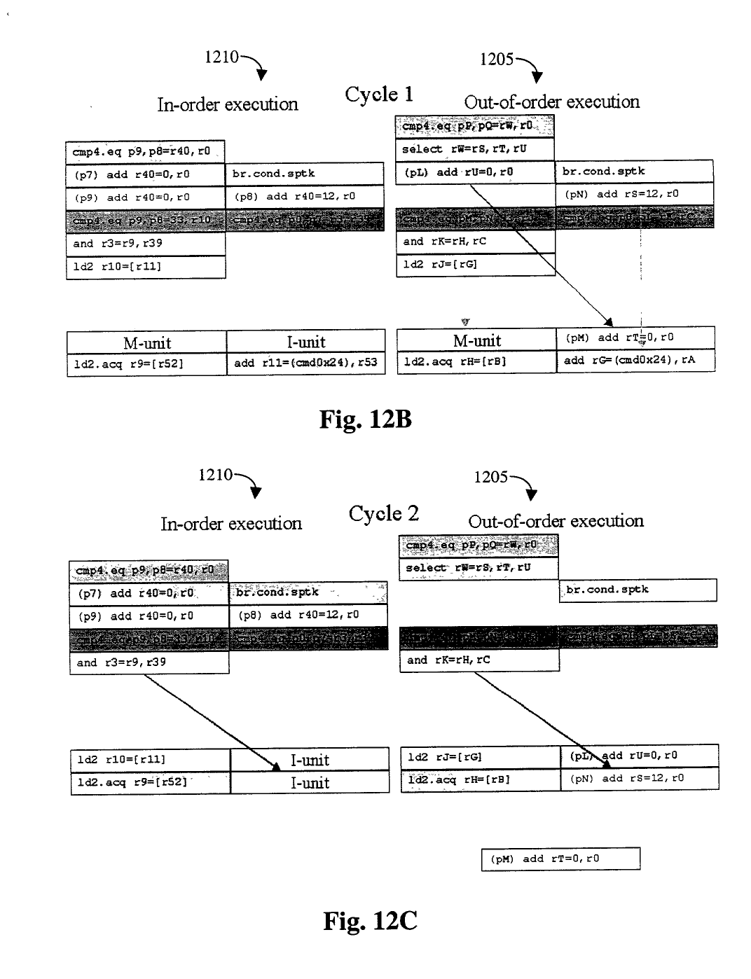

Once dispatched, the select-μop is executed. The value from one of the source operands is transferred to the destination register. One embodiment of the logic 1000 that executes the select-μop with source fan-in of 4 is shown in FIG. 10. This logic includes a cascade of three 2×1 multiplexers 1010, 1020, 1030. The p-bit is used to toggle the multiplexer select. Note that this is a logical view of the select-μop execution. The actual circuitry can be implemented in different ways, and an efficient implementation is needed to handle larger or smaller fan-ins. When a p-bit is set to 1, the output obtains the data from the corresponding source operand. Conversely when a p-bit is set to 0, the data is fetched from the output of another cascaded multiplexer. This logic 1000 correctly realizes the priority specified in the select-μop. Once the execution of select-μop completes, one of the source operands is assigned to the destination operand. The reservation station then receives the destination operand broadcast for all its uses.

One example presented below is extracted from the perl source code in SPEC95. The function is block_head in cons.c. In the middle of this function is a switch statement that branches to several case statements. The following code snippet is one example of the above described case statements.

case CFT_NUMOP:

opt = (tail->c_slen == O_NE ? 0 : CFT_NUMOP);
if ((tail->c_flags& (CF_NESURE | CF_EQSURE)) != (CF_NESURE | CF_EQSURE))

opt = 0;

break;

. . . . . . . }
If (opt && opt == last_opt && tail->c_stab == last_stab)

count ++;

The snippet above evaluates expressions and assigns a new value to the variable opt accordingly. After the execution of this code, the variable opt contains either the value CFT_NUMOP or 0 (zero) depending on two conditions:

Condition 1: tail->c_slen == O_NE
Condition 2: tail->c_flags&(CF_NESURE|CF_NEQSURE) !=

(CF_NESURE|CF_EQSURE)

To summarize, the variable opt is assigned the value according to the following condition matrix shown in Table 1

TABLE 1

| | Cond 1 False | Cond 1 True |
|---|---|---|
| Cond 2 False | CFT_NUMO | Zero |
| | P | |
| Cond 2 True | Zero | Zero |

The outcome of the variable opt is determined by an OR operation of condition 1 and 2. However, for this embodiment, the source code was not fully rewritten for a more succinct control flow. Therefore condition 2 post-dominates condition 1, the variable opt is assigned zero if condition 2 is true regardless of the outcome of condition 1. Even though the reverse is also true in this embodiment i.e. that opt is zero if condition 1 is true despite condition 2, it does not necessarily translate the same in other cases. In the present embodiment the total number of cycles is 6. An embodiment more fully rewritten for more succinct control flow can further reduce the execution process to 5 cycles.

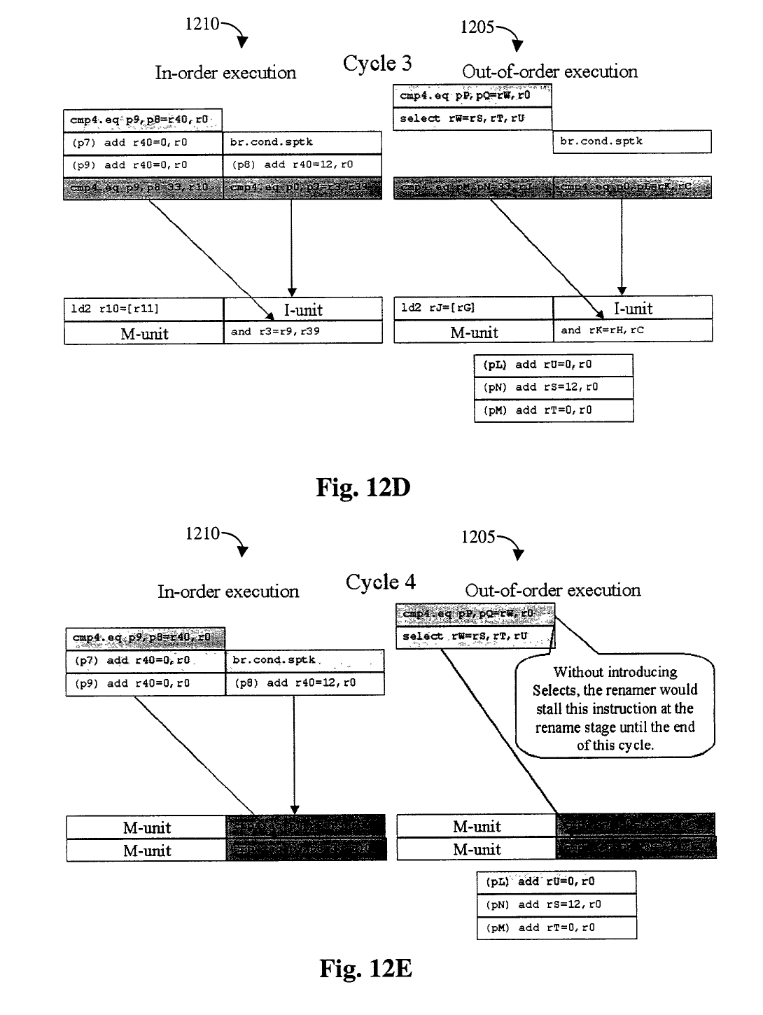

There are actually two independent threads of control flow merging at the end of the block. One thread is for the evaluation of condition 1 and the other is for condition 2. FIG. 11 illustrates a dependence graph 1100 of the code. On the left 1110 is condition 1 and the right 1120 is condition 2.

The compiler cannot schedule (p7) add r40=0,r0 to be executed simultaneously with the other two predicated instructions. The architectural definition of IA-64 prevents a register, namely r40, from being assigned a value more than once in a single cycle. Since the compiler cannot guarantee that p7 (condition 2) and the other predicates (condition 1) are mutually exclusive, the compiler cannot schedule all three instructions in a single cycle. However, in the dynamic execution embodiment, executing those three instructions simultaneously is possible due to register renaming.

For an alternative embodiment, the dynamic performance processor has three instructions in a bundle and the processor is limited to being one-bundle wide. Furthermore, the processor fetches instructions from I-cache in program order.

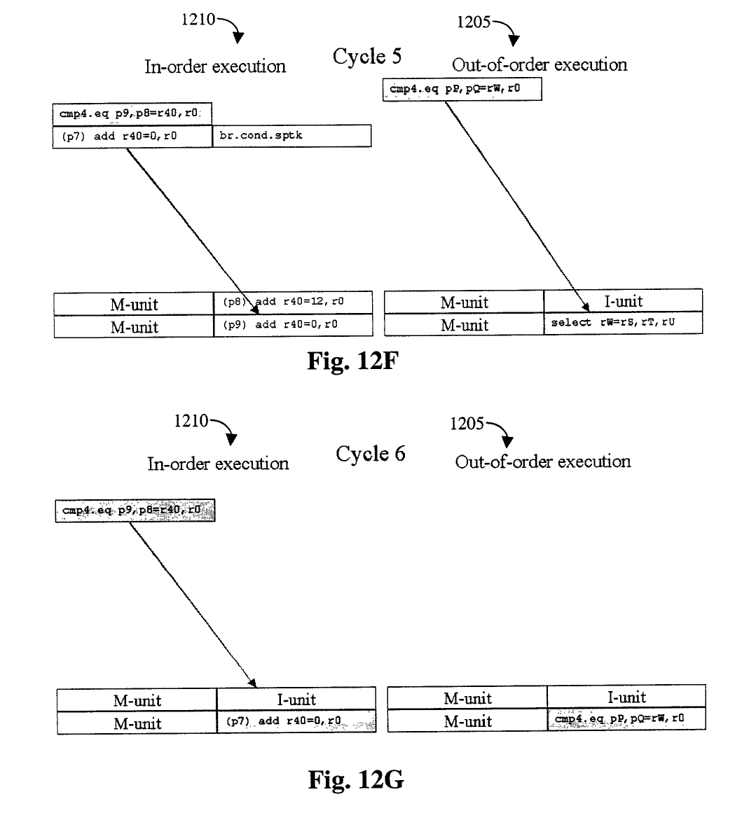

Once the instructions pass the renaming stage, all registers are renamed and each definition of a register is uniquely assigned a physical register. The registers in the pipeline have all numerical (architectural) register identifiers renamed to alphabetical (physical) register identifiers. In the pipeline diagram shown in FIGS. 12A-G, note that register r40, guarded by three different predicates, have also been renamed to rS, rT and rU.

After all registers have been renamed, the predicated register alias table (RAT) detects the renaming of r40, and dynamically attaches select-μops with the instruction bundle. Once the select-μops have been injected, the instructions enter the issue stage for dispersal. The issue unit disperses the instructions to several independent reservation stations. For one embodiment, the processor has a centralized reservation station dispatching instructions to two Integer functional units (I-unit) and two Memory functional units (M-unit). The reservation stations can dispatch any instruction when all except predicate dependencies are satisfied. The reason, as we previously mentioned, is that we can slip the predicated instructions and not commit their results until later when the predicate is known. We also assume that all integer operations take 1 cycle and load instructions 2 cycles. Since this paper does not deal with the dispersal rules of the issue unit, we simply assume a greedy algorithm that issues up to 4 instructions per cycles. FIGS. 12A-G illustrate benefits of select-μop dynamic execution on the right side 1205 of each figure. Static execution is illustrated on the left side 1210 of each figure for comparison.

FIG. 12A shows cycle 0. In cycle 0, both rA and rB are the live-in registers, so after 1 cycle, an I-unit executes add rG=( . . . ),rA and an M-unit executes ld2.acq rH=[rB]. Unlike static execution, since (pM) add rT=0,r0 does not depend on any register except the predicate; (pM) add rT=0,r0 also gets dispatched, but does not get committed until pM is known.

FIG. 12B shows cycle 1. After Cycle 1, rG becomes available and triggers the reservation station to dispatch ld2 rJ=[rG] to an M-unit. Since the load instructions take two cycles, ld2.acq rH=[rB] in the other M-unit will not be ready until after Cycle 2. Again, (pN) add rS=12,r0 is still not committed, and for the same reason as before, both I-units are to execute (pL) add rU=0,r0 and (pN) add rS=12,r0.

FIG. 12C shows cycle 2. After Cycle 2, rH is available, rC is a live-in. Thus and rK=rH,rC can be dispatched to an I-unit. The register rJ is still pending. One of the M-units will be free. The reorder buffer does not retire (pM) add rT=0,r0 because the predicate pM has not been evaluated.

FIG. 12D shows cycle 3. After Cycle 3, both rK and rJ are ready. Thus, both of the compare instructions can be dispatched. Also, all three predicated instructions now wait in the reorder buffer for the predicates to be resolved.

FIG. 12E shows cycle 4. Several actions take place after Cycle 4. First, all three predicates pM, pN, and pL have been calculated. The predicate dependencies are resolved and all three predicated instructions can immediately be committed.

Now, all of the “real” instructions have been executed, and the select-μop is ready to go. Due to renaming, the variable opt currently resides in rS, rT, and rU. By executing the select-μop, the correct value will be assigned to rW. Note that without using select-μop, the consumer of opt that immediately follows needs to be stalled, thus can result in more cycle counts than the static execution model.

FIG. 12F shows cycle 5. In Cycle 5, an I-unit evaluates the select-μop, thus results in 5 cycles total. At the end of this cycle, rW is ready for use. For the static execution model, another cycle is needed, thus result in 6 cycles total.

This embodiment shows that select-μops may require an extra cycle to move the value from one register to the other. However, the total execution time can be as low as 5 cycles, which is lower than the static schedule of 6 cycles as shown in FIG. 12G. In this embodiment even though extra cycles are required to execute select-μop, more cycles are saved with efficient dynamic execution.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A microprocessor comprising:
a plurality of dynamic pipeline stages including at least one predicated instruction wherein the predicated instruction includes a plurality of guarding predicates;
a register renaming unit;
a reorder buffer;
a plurality of execution units;
a plurality of reservation stations wherein the register renaming unit, the reorder buffer, the plurality of execution units and the plurality of reservation stations are coupled to at least one of the plurality of dynamic pipeline stages; and
an augmented register alias table.

2. The microprocessor of claim 1, wherein the register renaming unit renames each one of a plurality of source registers of the pipeline instruction and renames a destination register to a new physical register.

3. The microprocessor of claim 2, wherein the augmented register alias table includes a plurality of lines, and wherein each one of the plurality of lines includes a plurality of renamed destination registers.

4. The microprocessor of claim 3, wherein each one of a plurality of select-μops has a plurality of source operands wherein each one of the plurality of source operands corresponds to a physical register identifier.

5. The microprocessor of claim 4, wherein the plurality of source operands comprises a first source operand and a plurality of secondary source operands.

6. The microprocessor of claim 5, wherein the first source operand includes a default physical register identifier, wherein the default physical register is always valid and available.

7. The microprocessor of claim 5, wherein each one of the plurality of secondary source operands includes a plurality of status bits and a physical register identifier.

8. The microprocessor of claim 7, wherein each one of the plurality status bits has a ready bit and a committed bit.

9. A method of processing predicated instructions comprising:
receiving a plurality of predicated instructions assigned to a common defined destination register and wherein at least one of the plurality of predicated instructions is out of order in an dynamic pipeline;
renaming the destination register for each one of the plurality of predicated instructions;
assigning the corresponding renamed destination register for each one of the plurality of predicated instructions with a corresponding predicate register to corresponding ones of the a plurality of source operands of a select-μop;
determining a valid predicate in the source operands of the select-μop;
electing the register corresponding to the select-μop that corresponds to the valid predicate;
transferring the data in the selected register to the destination register; and
executing a consumer instruction wherein the consumer instruction uses the data from the destination register of the corresponding select-μop.

10. The method of claim 9, wherein the each one of the plurality of select-μops has a plurality of source operands wherein each one of the plurality of source operands corresponds to a physical register identifier.

11. The method of claim 10, wherein the plurality of source operands comprises a first source operand and a plurality of secondary source operands.

12. The method of claim 11, wherein the first source operand includes a default physical register identifier, wherein the default physical register is always valid and available.

13. The method of claim 11, wherein each one of the plurality of secondary source operands includes a plurality of status bits and a physical register identifier.

14. A computer system comprising:
a processor, wherein the processor includes:
a plurality of dynamic pipeline stages including at least one predicated instruction wherein the predicated instruction includes a plurality of guarding predicates;
a register renaming unit;
a reorder buffer;
a plurality of execution units;
a plurality of reservation stations wherein the register renaming unit, the reorder buffer, the plurality of execution units and the plurality of reservation stations are coupled to at least one of the plurality of dynamic pipeline stages; and
an augmented register alias table;
a system bus;
a computer memory system;
an input/output device;
wherein the system bus is coupled to the processor, the computer memory system and the input/output device.

15. The computer of claim 14 wherein, the augmented register alias table includes a plurality of lines, and wherein each one of the plurality of lines includes a plurality of renamed destination registers.

16. The computer of claim 15 wherein, the register renaming unit renames each one of the plurality of source registers of the pipeline instruction and renames the destination register to a new physical register.
